(19) United States
(12) Patent Application Publication
(10) Pub. No.: US 2005/0039301 A1
(43) Pub. Date: Feb. 24, 2005

(54) Hinge assembly

(76) Inventors: Sheng-Nan Lu, Shulin City (TW); Tien-Yueh Hsu, Shulin City (TW)

Correspondence Address: Jackson Walker L.L.P., Suite 2100, 112 E. Pecan Street, San Antonio, TX, 78205, US

(21) Appl. No.: 10/646,265

(22) Filed: Aug. 22, 2003

(51) Int. Cl. E05D 11/10

(52) U.S. Cl. 16/321

(57) ABSTRACT

A hinge assembly includes a fixing seat, a position seat having a first annular body and a second annular body opposite to the first annular body, a fixing ring securely engaged with the first annular body and having a pair of notches and a position ring having a pair of protrusions extending out to correspond to the pair of notches. A connection rod is provided to securely sandwich the fixing ring, the position ring and the multiple resilient pads between the first annular body and the second annular body so as to securely engage with a securing device. Pivotal movement of the position seat relative to the fixing seat drives the position ring to pivot such that the protrusions are alternatively received in the corresponding notches and thus the multiple resilient pads are able to provide necessary friction when the protrusions are away from the notches.

### BACKGROUND OF THE INVENTION

1. Field of the Invention

The present invention relates to a hinge assembly, and more particularly to a hinge assembly having a fixing ring with a notch defined in a side face thereof and a position ring with a protrusion formed on a side face thereof to correspond to the notch of the fixing ring such that when the protrusion is received in the notch, the position seat is fixed relative to the fixing seat and when the protrusion is away from the notch, movement of the position seat forces resilient pads to provide necessary friction for supporting the computer screen.

2. Description of Related Art

Hinge devices are commonly used everywhere in our lives to provide relative pivotal movement between objects. A common example is the hinge device used in a laptop computer. Normally, the hinge device has a fixing seat which is adapted to connect to the mainframe of the laptop computer and a position seat adapted to connect to the screen of the laptop computer. A friction element is provided between the fixing seat and the position seat so that when there is relative movement between the fixing seat and the position seat, the friction element is able to provide necessary friction to support the screen at a certain position. However, after being used for a period, the hinge device between the screen and the mainframe becomes worn. That is, the friction element can not provide the necessary friction any more due to the friction wear with both the fixing seat and the position seat. Once the friction is not enough, the screen can no longer be supported at a desired angle and thus the laptop computer user will have to adapt himself/herself to the screen position. The worst situation is that the user will have to rely on auxiliary devices to maintain the screen at a desired position, which is quite annoying and troublesome.

To overcome the shortcomings, the present invention tends to provide an improved hinge assembly to mitigate the aforementioned problems.

### SUMMARY OF THE INVENTION

The primary objective of the present invention is to provide an improved hinge assembly having a fixing seat, a position seat pivotal relative to the fixing seat, a fixing ring secured to the position seat and provided with a notch in a side face thereof and a position ring pivotal relative to the fixing ring and provided with a protrusion alternatively received in the notch. Therefore, when the protrusion is received in the corresponding notch, the screen is positioned and when the protrusion is away from the corresponding notch, axial movement of the position ring is able to compress resilient pads to provide the necessary friction to support the screen at a specific position relative to the mainframe.

Another objective of the present invention is that the fixing ring has a pair of extensions formed on the other side face thereof to correspond to a pair of cutouts circumferentially defined in the position seat such that when the extensions are received in the corresponding cutouts, the fixing ring is secured to the position ring and is able to pivot along with the position seat. However, the position seat is immovable relative to the fixing seat to allow the protrusion of the position seat to be movably received in the corresponding notch.

Other objects, advantages and novel features of the invention will become more apparent from the following detailed description when taken in conjunction with the accompanying drawings.

### BRIEF DESCRIPTION OF THE DRAWINGS

FIG. 1 is a perspective view of the hinge assembly of the present invention;

FIG. 2 is an exploded perspective view of the hinge assembly of the present invention;

FIG. 3 is schematic top plan view showing that the position seat is in a first horizontal position relative to the fixing seat;

FIG. 4 is a schematic top plan view showing that the position seat is extending upright relative to the fixing seat; and

FIG. 5 is a schematic top plan view showing that the position seat is in a second horizontal position relative to the fixing seat.

### DETAILED DESCRIPTION OF THE PREFERRED EMBODIMENT

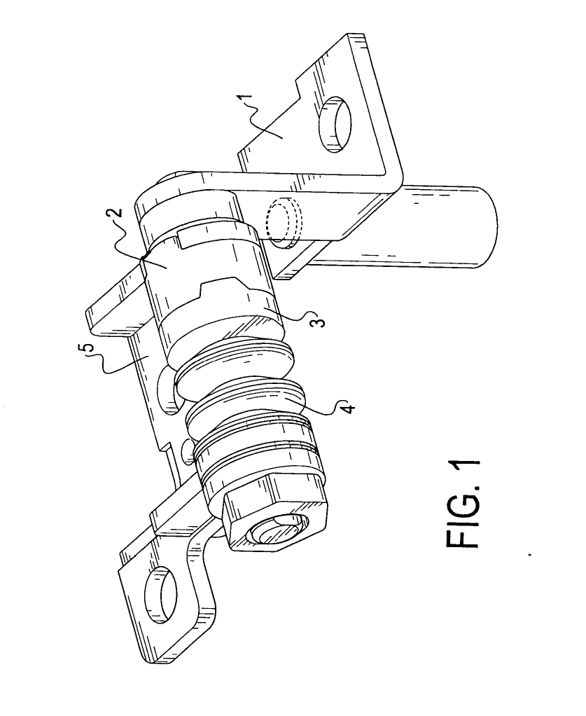

With reference to FIG. 1, the hinge assembly in accordance with the present invention includes a fixing seat (1), a fixing ring (2), a position ring (3), multiple resilient pads (4) and a position seat (5).

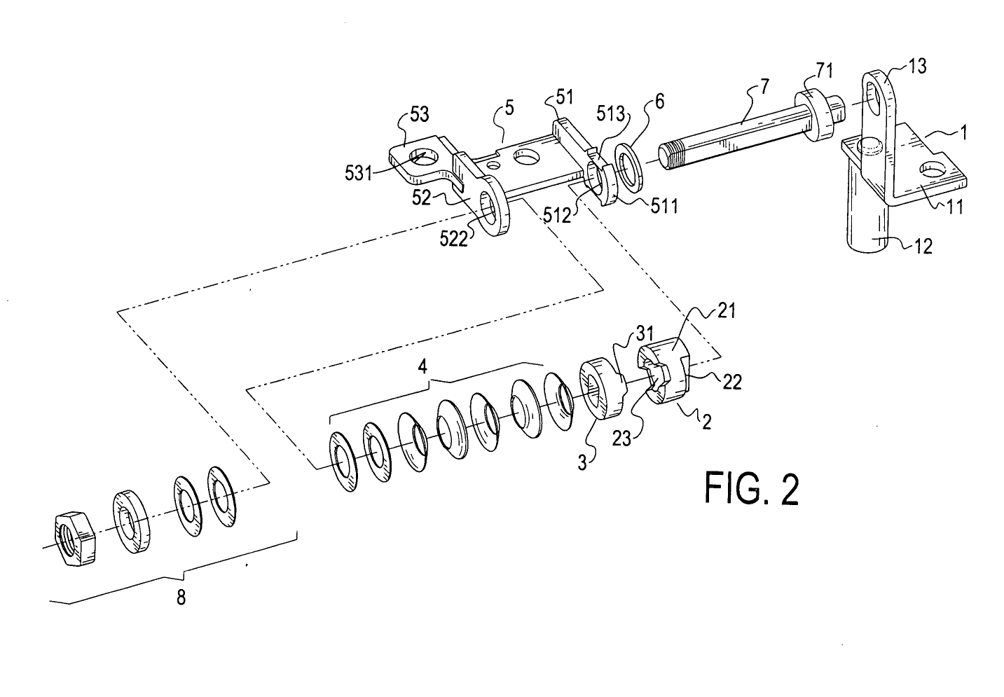

With reference to FIG. 2, the fixing seat (1) is composed of a plan body (11), a fixing leg (12) extending downward from the plan body (11) to be adapted to connect to a computer mainframe (not shown) and a connection plate (13) extending upright from the plan body (11) and defining therein a through hole (131).

The fixing ring (2) includes a pair of extensions (21) formed on a side face of the fixing ring (2), two recessed areas (22) defined to separate the two extensions (21) and a pair of notches (23) oppositely defined in a side face of the fixing ring (2) relative to the side face having the pair of extensions (21).

The position seat (3) has a pair of protrusions (31) oppositely extending from a side face of the position seat (3) to correspond to the pair of notches (23).

The resilient pads (4) are conical shapes and oppositely engaged with one another.

The position seat (5) has a first position bar (51) and a second position bar (52) securely connected to the first position bar (51). The first position bar (51) has an annular body (511) formed on a free end of the first position bar (51) and defining therein a first position hole (512) and a pair of cutouts (513) oppositely formed on a circumference of the annular body (511). The second position bar (52) has a second annular body (521) formed on a free end of the second position bar (52) and defining therein a second position hole (522). A second connection plate (53) extends out from the position seat (5) and defines therein a second through hole (531) for connection to the laptop screen.

A pad assembly (6) is provided between the fixing seat (1) and the position seat (5) to avoid direct engagement between the fixing seat (1) and the position seat (5).

A connection rod (7) is provided to extend through the through hole (131) of the fixing seat (1), the pad assembly (6), the first position hole (512), the fixing ring (2), the position ring (3), the resilient pads (4) and the second position hole (522) to connect to a securing device (8) so as to securely sandwich the fixing ring (2), the position ring (3) and the resilient pads (4) between the first annular body (511) and the second annular body (521). The securing device (8) may be a common combination of nut and pads so that engagement between the connection rod (7) and the securing device (8) may be accomplished by screwing the distal end of the connection rod (7) with the nut of the securing device (8).

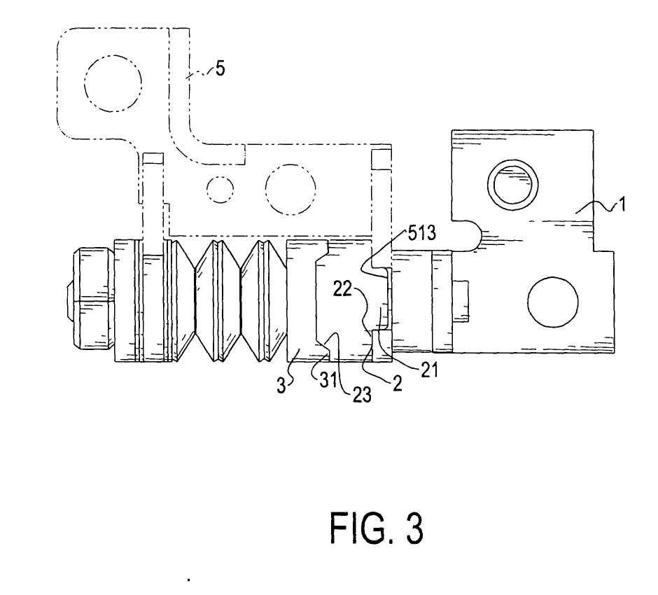

When the hinge assembly of the present invention is in assembly, the fixing seat (1) and the position seat (5) are respectively adapted to connect to the laptop mainframe (not shown) and the laptop screen. Then, the connection rod (7) is applied to extend through the through hole (131) of the fixing seat (I), the pad assembly (6), the first position hole (512), the fixing ring (2), the position ring (3), the resilient pads (4) and the second position hole (522) to connect to the securing device (8) so as to securely sandwich the fixing ring (2), the position ring (3) and the resilient pads (4) between the first annular body (511) and the second annular body (521). Thereafter, it is noted that the pair of extensions (21) is received in the corresponding cutouts (513) of the first annular body (511) so that the engagement between the fixing ring (2) and the position seat (5) is secured. Meanwhile, the protrusions (31) of the position ring (3) is received in the corresponding notch (23) of the fixing ring (2), which is shown in FIG. 3. Furthermore, while the protrusions (31) are received in the notches (23), the screen, which is connected to the position seat (5), is positioned securely.

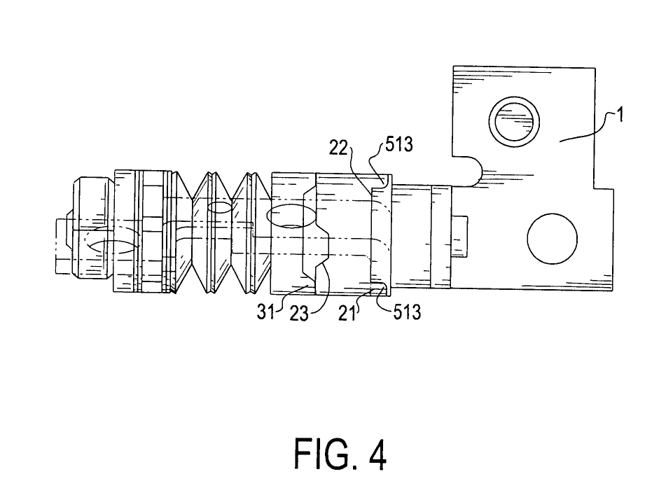

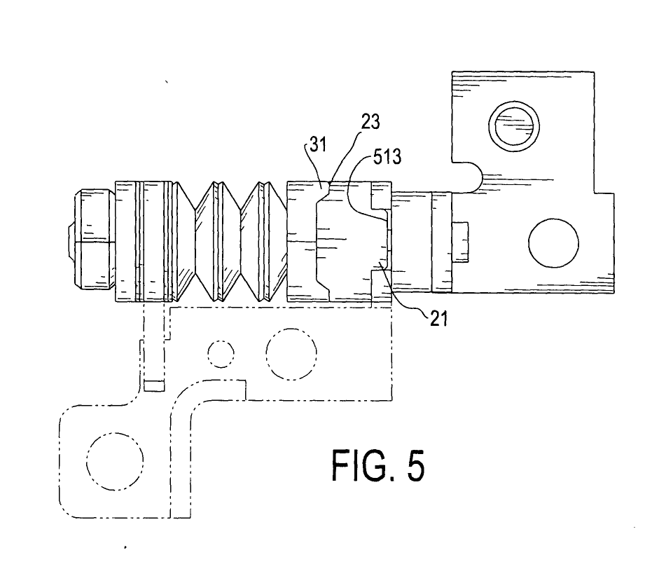

With reference to FIGS. 3, 4 and 5, it is noted that when the position seat (5) is at its first horizontal position relative to the fixing seat (1), because the extensions (21) are received in the corresponding cutouts (513) of the position seat (5) and the first annular body (511) is received in the recessed areas (22) of the fixing ring (2), the fixing ring (2) is secured relative to the fixing seat (1). Meanwhile, the protrusions (31) are respectively received in the notches (23) of the position ring (3). Therefore, the position seat (3), which is adapted to connect to the laptop computer screen, is securely positioned.

When the position seat (5) is pivoted to an upright position relative to the fixing seat (1), the engagement between the fixing ring (2) and the fixing seat (1) is unchanged. However, due to the pivotal movement of the position seat (5), the protrusions (31) are away from the corresponding notches (23), by which the position ring (3) is forced to have an axial movement away from the fixing ring (2). The axial movement of the position ring (3) thus compresses the resilient pads (4). Because the position ring (3) securely engages with the fixing ring (2), the compressed resilient pads (4) are able to provide the necessary friction to support the position seat (5) at a certain position

When the position seat (5) is again pivoted in the same direction as that discussed above, the protrusions (31) are moved into the corresponding notch (23) of the fixing ring (2), which again secures the engagement between the fixing ring (2) and the position ring (3) and a positioning effect to the position seat (5) is provided. Thus the screen, which is adapted to connect to the position seat (5), is supported.

It is to be understood, however, that even though numerous characteristics and advantages of the present invention have been set forth in the foregoing description, together with details of the structure and function of the invention the disclosure is illustrative only, and changes may be made in detail especially in matters of shape, size, and arrangement of parts within the principles of the invention to the full extent indicated by the broad general meaning of the terms in which the appended claims are expressed.

1. A hinge assembly comprising:
a fixing seat adapted to connect to a laptop computer mainframe;
a position seat adapted to connect to a laptop computer screen and having a first annular body defining therein a first position hole and a second annular body opposite to the first annular body and defining therein a second position hole;
a fixing ring having a first side face securely engaged with the first annular body and a second side face opposite to the first side face and provided with a pair of notches;
a position ring having a pair of protrusions extending out to correspond to and be alternatively received in the pair of notches of the fixing ring such that the position ring is able to have an axial movement relative to the fixing ring when the pair of protrusions of the position ring are not received in the corresponding pair of notches of the fixing ring;
multiple resilient pads;
a securing device; and
a connection rod extending through the fixing seat, the first annular body, the fixing ring, the position ring, the multiple resilient pads, the second annular body to securely sandwich the fixing ring, the position ring and the multiple resilient pads between the first annular body and the second annular body so as to securely engage with the securing device, wherein the first annular body has a pair of cutouts defined in a circumferences of the first annular body and the fixing ring has a pair of extensions formed on the first side face of the fixing ring to correspond to the cutouts so that engagement between the fixing ring and the first annular body of the position seat is secured when the extensions are received in the corresponding cutouts, wherein the fixing ring has a pair of recessed areas adjacent to the extension and oppositely formed to one another to receive therein the first annular body.
Whereby pivotal movement of the position seat relative to the fixing seat drives the position ring to pivot such that the protrusions are alternatively received in the corresponding notches and thus the multiple resilient pads are able to provide necessary friction when the protrusions are away from the notches.

2. (Cancelled herein).

3. (Cancelled herein).

4. (Cancelled herein).

5. (Cancelled herein).

6. (Cancelled herein).
